(19) United States
(12) Patent Application Publication
(10) Pub. No.: US 2011/0308381 A1
(43) Pub. Date: Dec. 22, 2011

(54) ARMOR

(75) Inventor: D. Kent Hartley, Butler, PA (US)

(73) Assignee: Standard Bent Glass Corporation, Butler, PA (US)

(21) Appl. No.: 13/166,176

(22) Filed: Jun. 22, 2011

Related U.S. Application Data
(60) Provisional application No. 61/357,189, filed on Jun. 22, 2010.

(51) Int. Cl. F41H 5/02; B23P 11/00

(52) U.S. Cl. 89/36.02; 29/428; 89/903; 89/917; 89/936

(57) ABSTRACT

An armor including a first panel having a first surface and a second surface and a second panel having a first surface facing the second surface of the first panel and a second surface. Wherein at least a portion of at least one of the first surface of the first panel and the second surface of the first panel is on a first plane that intersects a second plane defined by at least a portion of at least one of the first surface of the second panel and the second surface of the second panel.

### CROSS REFERENCE TO RELATED APPLICATION

The present application claims priority to U.S. Provisional Patent Application No. 61/357,189 filed on Jun. 22, 2010.

### BACKGROUND

Described herein are panels useful in armor for vehicles, such as military vehicles. Also described herein are methods of making and using such panels.

A challenge in manufacturing armor, such as transparent armor (also referred to as, e.g., ballistic glass), is how best to select materials and physical structures to optimize resistance to projectiles, heat or other detrimental forces, while retaining sufficient optical clarity for use as windows, portholes, visors, etc. For example, glass, can be layered to form laminates with a suitable resistance to projectiles.

In a simple example, laminated safety glass comprises two sheets of glass and a polymer interlayer (e.g., polyvinyl butyral (PVB)) bonded together. The PVB is sandwiched between the glass which is passed through rollers to expel any air pockets and form the initial bond. It is then heated to approximately 70° C. in an autoclave. This procedure preserves the visual appearance of monolithic glass. Such laminated glass is useful in manufacturing safety glass windshields because it has a high resistance to penetration, the interlayer prevents flying glass shards upon impact, and the glass is capable of deformation thus reducing impact forces during head strikes. The process for manufacturing safety glass can be extended to producing multi-layer structures of glass and/or polymer sheets or interlayers to produce additional thickness, resistance to impact, prevention of flying glass shards, etc. As a general rule, the thicker the laminate structure, the better resistant to impact, projectiles, and heat. Also, the thicker the laminate, the more difficult it is to obtain sufficient optical clarity. Further, as one would expect, the thicker the laminate, the more the laminate weighs. As such, desirable features of transparent armor include, without limitation, light weight, optical clarity and resistance to impact and heat.

### SUMMARY

In various embodiments, the present invention is directed to an armor including a first panel having a first surface and a second surface and a second panel having a first surface facing the second surface of the first panel and a second surface. Wherein at least a portion of at least one of the first surface of the first panel and the second surface of the first panel is on a first plane that intersects a second plane defined by at least a portion of at least one of the first surface of the second panel and the second surface of the second panel.

In various embodiments, the present invention is directed to a window. The window includes a frame and armor. The armor includes a first panel having a first surface and a second surface and a second panel having a first surface facing the second surface of the first panel and a second surface. Wherein at least a portion of at least one of the first surface of the first panel and the second surface of the first panel is on a first plane that intersects a second plane defined by at least a portion of at least one of the first surface of the second panel and the second surface of the second panel.

In various embodiments, the present invention is directed to a method of making armor. The method includes arranging a first panel having a first surface and a second surface with a second panel having a first surface facing the second surface of the first panel and a second surface. Wherein at least a portion of at least one of the first surface of the first panel and the second surface of the first panel is arranged on a first plane that intersects a second plane defined by at least a portion of at least one of the first surface of the second panel and the second surface of the second panel.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the invention. In such drawing:

FIGS. 1A and 1B are cross sectional views of armor according to various embodiments of the present invention;

FIG. 1C illustrates a perspective view of armor in a frame according to various embodiments of the present invention;

FIGS. 1D through 1H are cross sectional views of armor according to various embodiments of the present invention;

FIG. 2 illustrates armor panel orientations according to various embodiments of the present invention;

FIG. 3 is a cross sectional view of armor according to various embodiments of the present invention;

FIG. 4 is a cross sectional view of armor according to various embodiments of the present invention;

FIGS. 5A through 5C are photographs of panels after ballistics testing according to various embodiments of the present invention;

FIGS. 6A and 6B are photographs of panels after ballistics testing according to various embodiments of the present invention;

FIGS. 7A through 7C are photographs of panels after ballistics testing according to various embodiments of the present invention;

FIGS. 8A through 8C are photographs of panels after ballistics testing according to various embodiments of the present invention; and

FIGS. 9A and 9B are photographs of panels after ballistics testing according to various embodiments of the present invention.

### DESCRIPTION

Provided herein are embodiments of armor, e.g., transparent armor that combines lighter weight and superior armoring capability. The armor comprises two or more layers or panels, e.g., transparent panels. The transparent panels may be multi-layered structures comprising transparent panels of glass, crystal and/or polymer adhered to each other to form a laminate. The two or more transparent panels are configured with respect to each other to define a gap between the panels and are configured so that at least two or more surfaces of the panels are not parallel. A polymer insert (for example a wedge) such as a polyurethane, polycarbonate or acrylic may be used in lieu of an air gap. Any projectile passing through the transparent armor will have its path deflected from linear by the non-parallel surfaces within the armor. The surfaces facing any air gap in the structure may be treated with an anti-reflective coating to prevent internal reflections within the structure. Where the structure comprises one or more air gaps, the gap(s) may be filled with air or any gas, such as inert gas, including nitrogen and argon or mixtures thereof. The inclusion of one or more layers within the structure that are placed at an angle with respect to each-other (i.e., one or more of the panels are oriented in intersecting planes), forces a projectile, such as a bullet, to travel in a non-linear path, such as a serpentine path where three or more layers are included in the structure. By having an air-gap or polymer insert in the structure affords two or more opportunities for a projectile to flatten and spread its energy over a larger surface area. When the projectile hits a second surface at an angle (a more “glancing” blow), the path of the projectile is abruptly changed, the projectile may be deformed or shattered, the path of the projectile through the angled panel is increased by the changed angle can be increased. Projectiles traveling at any angle with respect to the armor will hit at least one surface of the multiple impact surfaces on the outward-facing sides of layers within the structure at an angle. By combining three or more layers, the path of any projectile can be bent, so as to dissipate the energy of the projectile. As indicated above, while gas may be used to fill gaps within the structure, other transparent substances, such as liquids, gels, polymers, adhesives, etc. may also be used to fill the gaps, thereby further increasing the resistance of the armor to penetration.

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of these ranges is intended as a continuous range including every value between the minimum and maximum values. For definitions provided herein, those definitions refer to word forms, cognates and grammatical variants of those words or phrases. All references are fully incorporated by such reference herein, solely to the extent of their technical disclosure and only such that it is consistent with this disclosure.

As used herein, the terms “comprising,” “comprise” or “comprised,” and variations thereof, in reference to defined or described elements of an item, composition, apparatus, method, process, system, etc. are meant to be inclusive or open ended, permitting additional elements, thereby indicating that the defined or described item, composition, apparatus, method, process, system, etc. includes those specified elements—or, as appropriate, equivalents thereof—and that other elements can be included and still fall within the scope/definition of the defined item, composition, apparatus, method, process, system, etc.

Armor, e.g., transparent, opaque or translucent armor, is described herein. The armor comprises two or more layers, or panels, that are either monolithic (consisting of a single, contiguous (unlaminated) piece of transparent material), or a laminate (comprising two or more monolithic panels or sheets bonded to each other. The layers of the armor are separated by a gap, and the layers are angled with respect to each other such that any projectile or other impact to the armor does not strike at least one layer of the armor perpendicularly. The effect of this is to provide no path for any projectile striking and passing through the armor that does not include the projectile striking a surface perpendicularly. This results in the deflection of the path of the projectile and an additional source of dissipation of the energy of the projectile within the armor. This can result in a lightening of the armor to achieve similar results as the case would be with all layers being parallel, or an increase in armor strength (e.g., resistance to penetration by a projectile, such as a bullet) for equal-weight of armor. Internal surfaces of the armor, facing gaps within the structure, typically comprise anti-reflective and/or anti-glare coating(s), thereby reducing and preferably eliminating or substantially eliminating internal reflections within the armor.

In the embodiments of the armor described herein, the armor comprises two or more layers. As used herein, any panel, sheet or layer is a three-dimensional structure having a thickness, and major dimensions such as the length and width of a rectangular or square panel, sheet or layer length, a diameter, radius or circumference of a circular panel, or other relevant dimensions for whatever shape the panel, sheet or layer is fabricated. The “area” of a panel, sheet or layer refers to the area of the sheet in its major dimensions (that is, not thickness). For example, the “area” of a 3″ (three inches) thick 2′ (two feet) by 3′ rectangular armor panel is π sq. ft. (six square feet) and the area of a 3″ thick circular armor panel having a radius of 10″ is n (10²) 314 sq in. (314 square inches). Often, but not exclusively, the armor, panels, sheets or layers are of uniform thickness (that is substantially uniform in thickness) over their entire area or a portion of their area. Because the armor described in embodiments herein may be transparent in its use for viewing, as is the case of windshields, vehicle widows, cockpit glass, portholes, visors, etc., a distorted view in many instances is not desirable. As such, and also for ease of fabrication and design, the viewing area of transparent armor (that portion of the armor that, when installed, is not blocked by non-transparent structures, such as frames or other reinforcement elements, in its intended use and which remains transparent) typically comprises two or more layers, each of uniform thickness.

As used herein, the term “laminate” refers to a sheet of material made by joining together two or more sheets, panels, layers, etc. using an interlayer, e.g., as described below. A laminate is not necessarily prepared by any defined lamination, bonding, adhesive, etc. method.

As used herein, a “portion” refers to less than an entire part of an item, object, etc. A portion of a panel therefore refers to a part of the panel less than the entire panel, and unless otherwise indicated, refers to a fraction of the area of the armor, layer, sheet or panel in its major dimensions.

In certain embodiments, structures, such as transparent armor, panels, sheets, layers or laminates are disclosed. As used herein, the term “transparent” refers to the ability of a structure to transmit light without significant reflection or absorption. Such light can be any wavelength, but for certain applications it is within the visible range. Transparent structures include laminates having refractive qualities, such as lenses. In certain other embodiments, the transparent laminate does not significantly distort or diffuse the light, referred to herein as “non-refractive transparent structures.” For example, non-refractive, optically transparent structures are often used where a substantially undistorted visual field of view is desirable, such as in automobiles or military vehicles, and include but are not limited to front windshields, rear windshields, windows, sunroofs, moon roofs and cockpits. Non-refractive, optically transparent laminates may have planar or curved or bent shapes, so long as the view is not substantially refracted. In another embodiment, a structure may be refractive, transparent structures. A structure having refractive qualities may be useful in certain applications, such as providing an enhanced angle of view. Transparent structures can also be used in any environment where optical properties of the structure are important such as military, residential and/or commercial windows, insulating glass units, marine and aircraft window glass, as well as cockpits and/or windows for land, air, space, water and under water vehicles. Transparent laminates can have any desired visible light, infrared radiation, or ultraviolet radiation transmission and reflection (e.g., ranging from greater than 0% to 100% transmission). For example, for windshield and front sidelight areas in the United States, the visible light transmission is typically required to be greater than or equal to 70%.

Shown herein are embodiments of armor comprising planar layers that have substantially uniform thickness. The shape of the armor in three dimensions, including choice of materials, three-dimensional shapes of materials, refractive qualities of the materials (e.g., to produce a desired refractive/lens quality to the armor) are a matter of design choice and optimization, and is well within the abilities of those of ordinary skill in the optics. For instance, the armor may be convex or concave (bubble outwards or inwards) when installed, yet still be non-refractive. Producing such an effect is well within the abilities of those of skill in the relevant arts.

In certain embodiments, the layers are of substantially uniform thickness, meaning, as with typical glass panels, the thickness of the panel or layer does not deviate significantly, that is more than 10%, 5%, 2.5%, 1% or 0.1%. In other embodiments, the layers are not of uniform thickness, for instance, they are thicker at one end than at another to create a wedge shape that produces, completely or in part, the angles between the surfaces.

Transparent panels, laminates or sheets for use as layers in embodiments of the armor described herein may be any useful optically transparent panel, including, without limitation, glass, polymer(s) and/or crystal(s), such as: float glass, tempered glass, annealed glass, heat-strengthened glass, anti-reflective glass (e.g., AMIRAN®, from Schott Glass of Elmsford, N.Y. or OPTI-View from Pilkington) low iron glass, borosilicate glass, silica glass, highly silicic glass, tempered glass, fused silica, soda lime glass, a polyurethane (e.g., QUINTIUM, Huntsman Krystalflex), an polycarbonate (Sabic Lexan®, one-way mirror glass, an acrylic, a glass ceramic, quartz crystal, crystal sapphire (crystal aluminum oxide, e.g., Al₂O₃), magnesium aluminate spinel (e.g., MgAl₂O₄), aluminum oxynitride spinel (AlON, e.g., Al₂₃O₂₇N₅), etc.

“Heat-resistant glass” or “heat resistant” refers to glass or other composition, such as a glass ceramic, capable of withstanding continuous temperatures greater than 1000° C. and/or resistant to thermal shock, such as rapid temperature fluctuations of greater than 500° C., and includes such products as PYREX, ROBEX, and KERALITE/PYROCERAM.

Safety glass is one type of transparent laminate. The properties of safety glass derive from a polymer interlayer placed between a first and a second layer of glass, which prevents spraying of shattered glass upon impact. A number of interlayers are available commercially such as polyvinyl butyral (PVB), ethylvinylacetate (EVA), polyurethane (PU), and SENTRYGLAS® ionoplast interlayer. Laminated glass may be referred to by the combined thickness of the layers forming the laminate. For example, and without limitation, in certain embodiments a safety glass laminate would be 3 mm glass/0.38 mm interlayer/3 mm glass, which produces a final product referred to as 6.38 laminated glass. It should be recognized that transparent panels in laminated glass applications can have a huge variety of thicknesses. Also, the number of layers may be varied in transparent laminates. While common windshield glass may comprise two transparent panels and one interlayer, other transparent laminates, such as ballistic glass or laminates, for e.g., military uses, may comprise additional layers and interlayers. For instance, a ballistic glass panel may comprise 10-20 transparent layers (panels) with 9-19 interlayers. Other examples include 3, 4, 5, 6, 7, 8, 9, 10, 11, 12, 13, 14, 15, 16, 17, 18 and 19 transparent layers with 2, 3, 4, 5, 6, 7, 8, 9, 10, 11, 12, 13, 14, 15, 16, 17 and 18 interlayers, respectively. Further, each individual layer and interlayer can have different compositions, and each constituent, i.e., monolithic panel within a laminate, may have different thicknesses. For example, glass and polymeric panels may be mixed in the laminate to provide in each layer different physical (e.g., weight, rigidity, etc.) and/or optical characteristics (e.g., refractive index). For example, polyurethane layers and polycarbonate layers may be used in the same laminate. Likewise, polymeric layers may be sandwiched between glass or quartz crystal layers to yield a lighter-weight laminate. In some instances, it may be desirable that the inward-most layer is a polymer, such as a polycarbonate. The inward-most surface of the armor may be treated with an anti-fog agent, coating or film. Any layer, interlayer, or other constituent of the armor may be dyed or otherwise colored. For instance one or more layers, or an interlayer or film may include a polarizing treatment.

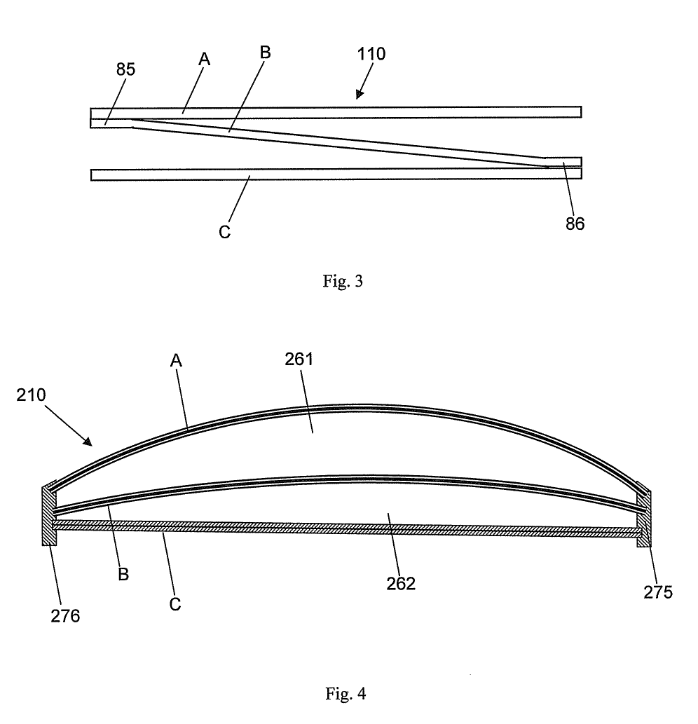

In the armor described herein, the respective layers, separated by gaps, typically comprise from one to five bonded transparent layers. For example, as shown in FIG. 3, the armor comprises two, three-panel layers and a two-panel layer.

Heating elements, such as resistance heating elements, broadly known in the art, may be included in laminates, for e.g., de-fogging purposes. The heating element(s) may be placed in any interlayer in such a multi-layered laminate. Resistive heating elements may comprise fine wires or conductive interlayers.

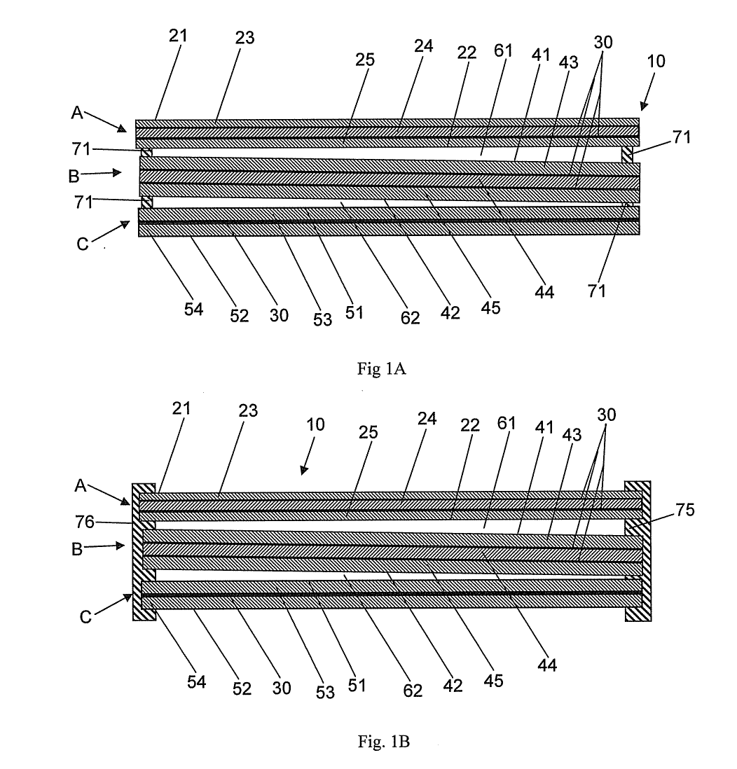

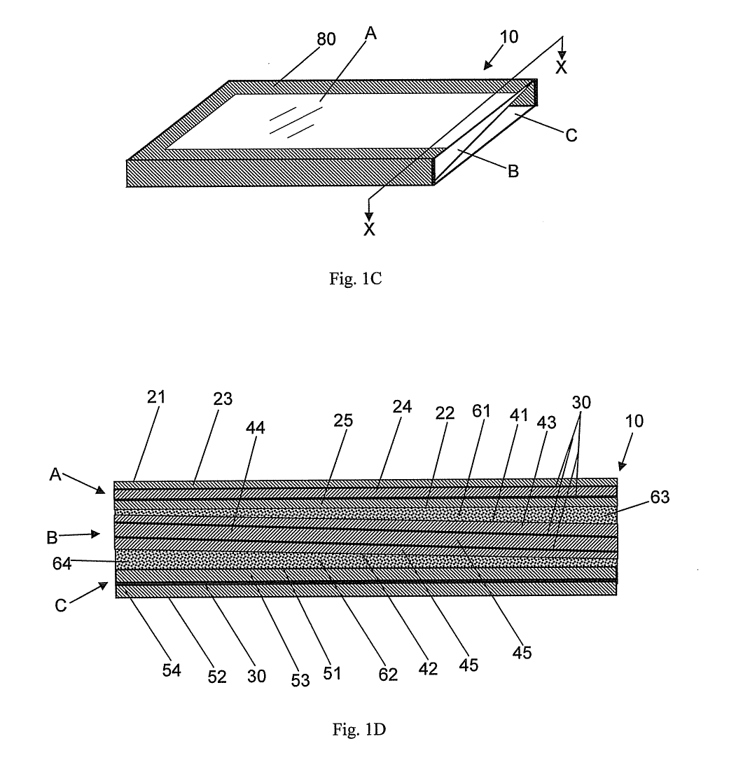

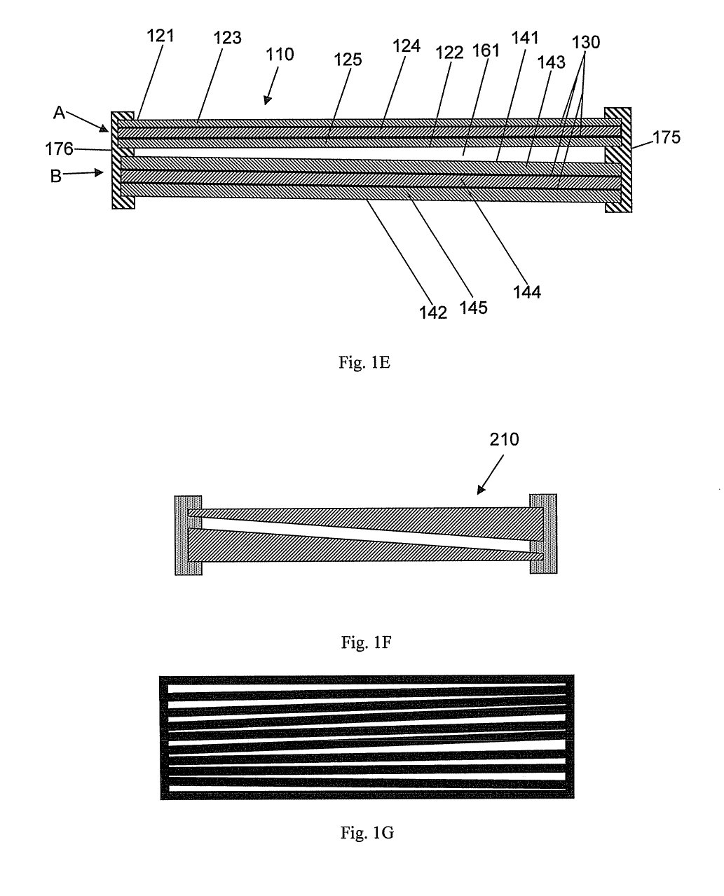

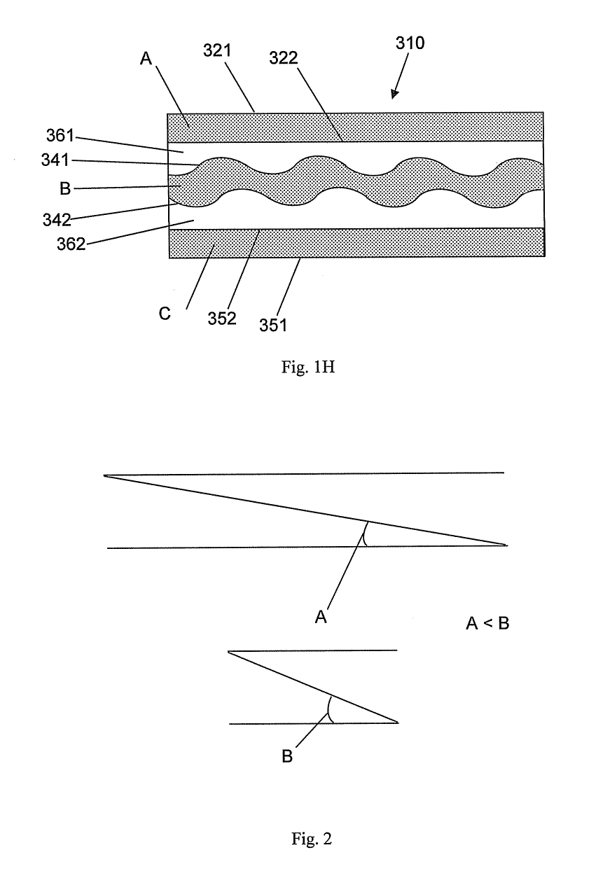

FIG. 1A depicts schematically a cross-section of one embodiment of transparent armor 10 described herein. All layers and interlayers are sufficiently transparent for use as a window in a vehicle. Transparent armor 10 is shown with three layers A, B and C. Layer A has a first side 21 and a second side 22. Transparent panels 23, 24 and 25 are shown separated by interlayers 30. Layer B has a first side 41 and a second side 42. Transparent panels 43, 44 and 45 are shown separated by interlayers 30. Layer C has a first side 51 and a second side 52. Transparent panels 53 and 54 are shown separated by interlayer 30. Second surface 22 of layer A and first surface 41 of layer B face each-other, and so gap 61 is defined by second surface 22 of layer A and first surface 41 of layer B. Likewise, gap 62 is defined by second surface 42 of layer B and first surface 51 of layer C. Spacers 71 are shown schematically, which are placed between layers A and B or B and C, respectively. Spacers 71 for gap 61 are shown as being smaller on the left and larger on the right, and spacers 71 for gap 62 are shown as being larger on the left and smaller on the right. This results in layer B not being oriented in parallel to either layer A or layer C. In use, armor 10 is placed in a suitable frame or otherwise inserted into a window, porthole, cockpit, etc. opening of a vehicle. A frame 80 (see FIG. 1C) or other structure for facilitating placement of armor 10 into a vehicle may overlap at least a perimeter portion of the armor 10 so as to hide the spacers 71. In one embodiment, one or more, and in one embodiment, all of transparent panels 25, 43, 45 and 51 are anti-reflective panels or have been treated with an anti-reflective coating, such that surfaces 22, 41, 42 and 51 are anti-reflective. For example and without limitation, panels 25, 43, 45 and 51 are AMIRAN® glass (Schott Glass of Elmsford, N.Y.). In another embodiment, panel 23 is a one-way mirror. In yet another embodiment, panel 51 is a polycarbonate.

An alternate embodiment to those depicted in FIGS. 1A and 1B is presented in FIG. 1D (like reference numbers refer to like structures in FIGS. 1A and 1B). Rather than air gaps (61 and 62 in FIGS. 1A and 1B), the gaps are filled with transparent polymeric wedges 63 and 64. Because there is no air gap, in this embodiment, the spacers (e.g., 71 in FIG. 1A) are not necessary. Any polymer may be used as a polymeric wedge 63, 64, such as an acrylic, polycarbonate or polyurethane (e.g., an aliphatic polyurethane), and as an example, as shown in Example 1 hereinbelow, a cast, transparent polyurethane, such as QUINTIUM (The Hanson Group, LLC), CLEARGARD® (BAE Systems), and NTP (PPG).

FIG. 1E depicts schematically a cross-section of a two-layer embodiment of transparent armor 110 described herein. As above, all layers and interlayers are sufficiently transparent for use as a window in a vehicle. Transparent armor 110 is shown with two layers A and B. Layer A has a first side 121 and a second side 122. Transparent panels 123, 124 and 125 are shown separated by interlayers 130. Layer B has a first side 141 and a second side 142. Transparent panels 143, 144 and 145 are shown separated by interlayers 130. Gap 161 is defined by second surface 122 of layer A and first surface 141 of layer B. Frames 175 and 175, including spacer sections, are shown schematically, which are placed between layers A and B. The spacer sections of frames 175 and 176 for gap 161 are shown as being smaller on the left and larger on the right.

FIG. 1F depicts an alternate embodiment of transparent armor 210 with wedge-shaped layers. As with any layer, the wedge-shaped layers each can comprise one or more panels. Although the figure depicts two wedge-shaped panels, the structure may include one uniform-thickness panel and one or more wedge-shaped panels in any configuration that results in non-parallel surfaces as are contemplated herein.

Although two and three-panel structures are depicted in the Figures, more than three panels may be used to produce an effective structure. As can be seen in Example 1 hereinbelow, the tested structures comprising an air gap or polymeric “gap” were 2-3 inches thick, while typical transparent armor can be up to 10 inches thick or thicker. The 2-3 inch thick panels of Example 1 have effective internal angles of the interior panels of less than one degree from parallel. These structures of less than three inches are seen to be effective to stop a projectile, alter projectile trajectories and effectively reduce impact energy. As such, use of, for example 4-10 laminate panels in the structure with 3-9 internal air gaps or polymer inserts (e.g., wedges) produce a highly-effective structure of much lighter weight than traditional 3-10 inch-thick panels made from parallel-aligned transparent panels (a 10-panel structure is depicted schematically in FIG. 1G, showing only panels and gaps). Of note in FIG. 1G, the inner panels are skewed first in one direction and then in another with respect to the parallel outer panels—a structure that affects the path of a projectile. An armor structure may comprise both air gaps and polymer inserts.

In yet another embodiment, shown for example in FIG. 1H, a waved or bent internal layer B is used instead of a planar internal layer as is shown in FIGS. 1A-1G. In this embodiment, outer layers A and C, each comprise an outward-facing surface 321 and 351, respectively and an inward-facing surface, 322 and 352, respectively. Internal layer B has two waved surfaces 341 and 342 which are not aligned, though the waves on the surfaces may be aligned in other embodiments. Glass with waved or bent layers can be formed according to known methods, for instance by casting in a mold, if appropriate for the material used for the layer. One or both internal surfaces (e.g., 341 or 342, as shown in FIG. 1H) comprise the waves, which may be desirable in an embodiment where no internal layer is present. Multiple internal layers may be used, either aligned with waves in the same direction or in a different direction (e.g., rotated 45° or 90°).

In embodiments (not shown) of any armor structure described herein, resistive heating wires may be placed in or adjacent to one or more interlayers (that is, between adjacent sheets in a laminate), and/or one or more of the interlayers are resistive heating elements, such that when an electric current is passed through the interlayer or wires passing through the interlayer, the armor heats up, exhibiting anti-fogging/anti-fouling characteristics. The interlayer(s) comprising the heating element(s) may be substantially or effectively transparent. For example, in certain systems, the transparent interlayer comprises multiple fine wires (e.g., tungsten) in an array connected to a positive and negative bus bar at opposite sides of a window. There are many bus bar variants which include, for example, solder bus bars, adhesive bus bars, and pre-shaped bus bars.

Another embodiment of the armor 10 shown schematically in FIG. 1A is depicted in cross-section in FIG. 1B. In FIGS. 1A, 1B and 1C, like reference numbers and letters refer to like structures. In FIG. 1B, spacers are integrated with a frame. Left frame element 75 and right frame element 76 are shown, comprising grooves in which layers A, B and C are inserted to hold layers A, B and C in position. FIG. 1C depicts schematically a cut-away (on right) view elevation of armor 10 depicted in FIG. 1B, showing frame 80.

In the context of the present disclosure, one or more surfaces of two or more layers are not parallel, meaning that a portion of the surfaces (e.g., planes on the surface) are not geometrically parallel, and are angled with respect to each-other, as is depicted, for example, in FIGS. 1A-1C. In various embodiments, the angle that the surfaces lay with respect to each-other is least 0.1°, including 0.1° to 10° and increments therebetween, including 0.25°, 0.5° , 1°, 2°, 2.5°, 3°, 4°, 5°, 6°, 7°, 8°, 9°, and 10° and fractions therebetween. In one embodiment, the angle ranges from 0.5° to 1.0°, and in another the angle is approximately 0.8° to 0.9°, for example approximately 0.85°. The limitations on the angle by which non-parallel surfaces are configured with respect to each-other depends on the desired maximum thickness of the structure, given the larger the length and/or width of the structure, the smaller the maximum possible angle of the surfaces within the structure for any given thickness. As such, a 5 inch-thick panel that is 6inches in its smallest dimension would be larger than the maximum angle for a 5 inch-thick panel that is 36 inches in its smallest dimension (see FIG. 2).

It should be recognized that although two-layer and three-layer structures are shown, structures having additional layers (i.e., four or more layers), are contemplated, and are within the scope of the present disclosure. Each layer may be angled as described herein, to achieve additional benefits. The two or more internal layers of four or more-layered structures may be non-parallel to each-other and the outer layers as is depicted in FIG. 1G. Although FIG. 1G shows layers angled with respect to each other in two dimensions, the various layers may be angled in any direction with respect to the outer layers, for example in a variation of the structure depicted in cross-section on FIG. 1G, one or more layers may be angled in a direction perpendicular (or any other angle), such that a cross section of the same structure taken at 90° (or any other angle) to the cross-section would show different angles formed by the internal layers and in which one or more internal layers are not parallel with the outer layers.

When installed in a vehicle, structure (e.g., building), etc., an armor panel as described herein will have an outward-facing side and an inward-facing side (facing the interior, and/or any protected person(s) and/or articles within, e.g., a vehicle or structure). In an installation embodiment, an outer surface armor is flush with the exterior of a vehicle. In various embodiments, the inward-facing surface of the armor is flush with interior surfaces of the vehicle. As such, as is shown, for example, in FIGS. 1A-1C, the outward-facing and inward-facing surfaces (e.g., surfaces 21 and 52 of FIGS. 1A and 1B), and therefore, the inner and outer layers (e.g., layers A and C of FIGS. 1A and 1B) are parallel, and one or more intermediary layers (e.g., layer B of FIGS. 1A and 1B) is not parallel to either or both of the inward-facing and outward-facing layers. In use, a configuration may be arranged as shown in

FIGS. 1A and 1B, in which an outward-facing surface of a second or third layer (e.g., layers B and/or C of FIG. 1A or 1B) is not parallel to an outward-facing layer or surfaces thereof. If a third layer is present, as is shown in FIG. 1A or 1B as layer C, the third layer or an outward-facing surface thereof, is not parallel with a surface of a more outward layer, such as the layer immediately adjacent to that layer in an outward-facing direction. In such a case, a projectile, when passing through the armor from the outside, will have its path changed by the second layer and the third layer, thereby diffusing the energy of the impact twice in this manner. Additional layers, as desired, may be added.

As can be seen in FIGS. 1A-1C, for example, for layers that are equally thick over their entire area, both surfaces of the middle layer are not parallel with both surfaces of either outer layer. This is an exemplary embodiment, as in various embodiments armor as described herein is made from laminates or single-sheet layers of glass, polymer, etc, of uniform thickness because such material is commonly available. Nevertheless, it should be recognized that panels may not necessarily be of uniform thickness, so for purposes herein, the surfaces of the layers are described as being at an angle to each-other, rather than some reference plane internal to the layer.

In another embodiment, shown schematically in cross-section in FIG. 3, armor 110 comprises layers A, B and C, which can be laminates or single-layer structures. In this embodiment, ends 85 and 86 of layer B are angled, or bent, and may be bonded to layers A and C, respectively. Spacers and a frame, not shown, can be added to support the armor 110 structure.

FIG. 4 depicts another embodiment of the armor described herein. The armor comprises laminate layers A, B and C, defining gaps 261 and 262, and frames 275 and 276. In this embodiment, two of the three layers are curved, effectively creating an angle between planes of layers A and B at any given point, though it should be noted that at at least one point in the center of the armor, layers A and B are parallel. As such, layer C is angled with respect to layers A and B so that all projectile paths through layers A, B and C include the projectile striking a surface non-perpendicularly. As above, layers may comprise anti-reflective treatment to reduce internal reflections. In embodiments utilizing curved glass, image distortion may occur, which may be undesirable or desirable in various instances.

Although the embodiments described herein refer to transparent panels, and the desire for transparency, one or more surfaces or layers of the armor, or portions thereof, may be translucent to pass light, but not images. Also, in various embodiments, one or more surfaces or layers of the armor, or portions thereof, may be opaque to pass light. These embodiments may be preferred in instances where light is desirable, but transparency is undesirable. Also, it can be understood that although embodiments of the present invention are described herein as being arranged as windows, the teachings of the present invention may be applied to any type of armor, including any type of battlefield or vehicle armor.

In any embodiment described herein, spacers can be any suitably supportive material, including glass, polymer, silicone, metal ceramic, etc. or combinations thereof.

Also provided is a method of making transparent armor comprising arranging (configuring, assembling, etc.) a first layer having a first surface and a second surface, and a second layer having a first surface facing the second surface of the first layer, and a second surface, separated by one or more spacers, such that the second surface of the first layer and the first surface of the second layer define a first gap, and wherein at least a portion of one or both of the first and second surfaces of the first layer and the first surface of the second layer are not parallel. The first layer and the second layer may be of substantially uniform thickness. A third layer also can be added. The method may further comprise arranging a third layer comprising a first surface a second surface adjacent to the second layer, opposite the first layer, such that the first surface of the third layer faces the second surface of the second layer, the first surface of the third layer and the second surface of the second layer defining a second gap. The layers may be arranged such that at least a portion of the first surface of the third layer and the first or second surface of the first layer are parallel. In the method, at least one of the first, second and third layers may be a laminate of two or more transparent, monolithic sheets. As above, the monolithic sheets may comprise float glass, tempered glass, annealed glass, low iron glass, borosilicate glass, silicic glass, highly silicic glass, tempered glass, fused silica, soda lime glass, a polyurethane (e.g., QUINTIUM), an polycarbonate, an acrylic, a glass ceramic, quartz crystal, crystal sapphire (crystal aluminum oxide, e.g., Al₂O₃), magnesium aluminate spinel (e.g., MgAl₂O₄), aluminum oxynitride spinel (AlON, e.g., Al₂₃O₂₇N₅), etc.

### EXAMPLE 1

### 0.30 Cal M61 Testing of Transparent Armor Samples

Ballistic testing was conducted using several transparent armor samples. Each of the targets was approximately 16-inches×16-inches and ranged from 2 to 3 inches thick. The structure of the panels are described in Tables A-E. AR1=one-side-coated abrasion-resistant polycarbonate. CTPU=cast transparent polyurethane. Air gaps and angled CTPU wedges are 12 mm thick at one end and 6 mm thick at the other end, resulting in a 6 mm difference over 16 inches (1.47%, or at a 0.85 degree angle from parallel with respect to the outer layers) (see, FIG. 1A for a schematic depiction of the overall structure of panels W1, W2 and W2, with gaps 61 and 62 being air in panel W1 and CTPU in panels W2 and W3).

TABLE A
Control panel 1

| | | | |
|---|---|---|---|
| MM | IN | MKUP | WT |

| | | | | |
|---|---|---|---|---|
| 10 | 0.375 | ⅜ | Glass | 5.1 |
| 0.63 | 0.025 | .025 | Urethane | 0.15 |
| 10 | 0.375 | ⅜ | Glass | 5.1 |
| 0.63 | 0.025 | .025 | Urethane | 0.15 |
| 12 | 0.487 | ½ | Glass | 6.54 |
| 0.63 | 0.025 | .025 | Urethane | 0.15 |
| 12 | 0.487 | ½ | Glass | 6.54 |
| 1.28 | 0.050 | .050 | Urethane | 0.3 |
| 3 | 0.118 | ⅛ | PC | 0.7 |
| 0.63 | 0.025 | .025 | Urethane | 0.15 |
| 3 | 0.118 | ⅛ | AR 1 | 0.7 |

| | |
|---|---|
| 53.8 | Total thickness |

TABLE B
Control panel 2, air gap

| | | | |
|---|---|---|---|
| MM | IN | MKUP | WT |

| | | | | |
|---|---|---|---|---|
| 8 | 0.312 | 5/16 | Glass | 4.2 |
| 0.63 | 0.025 | .025 | Urethane | 0.15 |
| 8 | 0.312 | 5/16 | Glass | 4.2 |
| 10 | | ⅜ | spacer | |
| 8 | 0.312 | 5/16 | Glass | 4.2 |
| 0.63 | 0.025 | .025 | Urethane | 0.15 |
| 6 | 0.23 | ¼ | Glass | 3.4 |
| 10 | | ⅜ | spacer | |
| 3 | 0.118 | ⅛ | PC | 0.7 |
| 0.63 | 0.025 | .025 | Urethane | 0.15 |
| 3 | 0.118 | ⅛ | AR 1 | 0.7 |

| | |
|---|---|
| 57.89 | Total thickness |

TABLE C
Angled air gap (Panel W1)

| | | | |
|---|---|---|---|
| MM | IN | MKUP | WT |

| | | | | |
|---|---|---|---|---|
| 8 | 0.312 | 5/16 | Glass | 4.2 |
| 0.63 | 0.025 | .025 | Urethane | 0.15 |
| 8 | 0.312 | 5/16 | Glass | 4.2 |

| | |
|---|---|
| 9 | ASSYMETRICAL AIR GAP |

| | | | | |
|---|---|---|---|---|
| 8 | 0.312 | 5/16 | Glass | 4.2 |
| 0.63 | 0.025 | .025 | Urethane | 0.15 |
| 6 | 0.23 | ¼ | Glass | 3.4 |

| | |
|---|---|
| 9 | ASSYMETRICAL AIR GAP |

| | | | | |
|---|---|---|---|---|
| 3 | 0.118 | ⅛ | PC | 0.7 |
| 0.63 | 0.025 | .025 | Urethane | 0.15 |
| 3 | 0.118 | ⅛ | AR1 | 0.7 |

| | |
|---|---|
| 55.89 | Total thickness |

TABLE D
Angled cast transparent polyurethane gap (Panel W2)

| | | | |
|---|---|---|---|
| MM | IN | MKUP | WT |

| | | | | |
|---|---|---|---|---|
| 8 | 0.312 | 5/16 | Glass | 4.2 |
| 0.63 | 0.025 | .025 | Urethane | 0.15 |
| 8 | 0.312 | 5/16 | Glass | 4.2 |
| 1.28 | 0.050 | .050 | Urethane | 0.3 |

| | |
|---|---|
| 9 | CTPU WEDGE AT CENTER POINT |

| | | | | |
|---|---|---|---|---|
| 1.28 | 0.050 | .050 | Urethane | 0.3 |
| 6 | 0.23 | ¼ | Glass | 3.4 |
| 0.63 | 0.025 | .025 | Urethane | 0.15 |
| 6 | 0.23 | ¼ | Glass | 3.4 |
| 1.28 | 0.050 | .050 | Urethane | 0.3 |

| | |
|---|---|
| 9 | CTPU WEDGE AT CENTER POINT |

| | | | | |
|---|---|---|---|---|
| 1.28 | 0.050 | .050 | Urethane | 0.3 |
| 3 | 0.118 | ⅛ | PC | 0.7 |
| 0.63 | 0.025 | .025 | Urethane | 0.15 |
| 3 | 0.118 | ⅛ | AR1 | 0.7 |

| | |
|---|---|
| 59.01 | Total thickness |

TABLE E
Angled cast transparent polyurethane gap,
alternate embodiment (Panel W3)

| | | | |
|---|---|---|---|
| MM | IN | MKUP | WT |

| | | | | |
|---|---|---|---|---|
| 10 | 0.375 | ⅜ | Glass | 5.1 |
| 0.63 | 0.025 | .025 | Urethane | 0.15 |
| 10 | 0.375 | ⅜ | Glass | 5.1 |
| 0.63 | 0.025 | .025 | Urethane | 0.15 |
| 12 | 0.487 | ½ | Glass | 6.54 |
| 1.28 | 0.050 | .050 | Urethane | 0.3 |

| | |
|---|---|
| 9 | CTPU WEDGE AT CENTER POINT |

| | | | | |
|---|---|---|---|---|
| 1.28 | 0.050 | .050 | Urethane | 0.3 |
| 3 | 0.125 | ⅛ | Glass | 1.7 |
| 1.28 | 0.050 | .050 | Urethane | 0.3 |

| | |
|---|---|
| 9 | CTPU WEDGE AT CENTER POINT |

| | | | | |
|---|---|---|---|---|
| 0.63 | 0.025 | .025 | Urethane | 0.15 |
| 3 | 0.118 | ⅛ | AR1 | 0.7 |

| | |
|---|---|
| 61.73 | Total thickness |

The 0.30 cal M61 was used to produce the threat rounds during this effort. The 0.30 caliber M61 rounds utilized in this program were of unclear pedigree. The projectiles were armor piercing projectiles consisting of a hardened steel core contained within a copper/gilding metal jacket. A NATO M61 projectile has a small amount of lead filler in the tip, and the total projectile weight is 150.5 grains with the armor piercing core accounting for approximately 55 grains. The projectile used in this example had no lead filler. Additionally, the measured hardness of the core was RC 60 with a weight of 58 grains. The projectiles were hand-loaded to achieve the desired impact velocity.

A universal gun mount was used to hold the 0.30 cal rifled barrels needed for the M61 testing. A bore mounted laser was used to align the gun with the desired impact location. For safety reasons the gun was fired remotely by pulling a steel lanyard. Prior to testing, warm-up shots were taken to ensure correct muzzle velocity, exact shot location relative to the laser, and to confirm stable projectile flight. A cardboard yaw card, positioned in the target fixture was used to check for excessive yaw.

Projectile impact velocities were measured using two sets of Oehler Model 57 photoelectric chronographs located between the gun and the target. The spacing between each set of chronographs was 48 inches. Calibrated Hewlett Packard HP 53131A universal counters, triggered by the chronographs, recorded the projectile travel time between screens. Projectile velocity was then calculated using the recorded travel times and the known travel distance. An average of the two calculated values was recorded as the screen velocity.

Targets were mounted against a rigid target frame with horizontal and vertical adjustments to adjust impact location. The frame was approximately 20-feet from the test weapon. The glass samples were mounted with their lower edge parallel to the ground surface and the strike face normal to the gun. Tests 1-6 utilized a two shot pattern, with shots spaced 7.5-inches apart. All other tests performed during this series were single shots on the center of the sample. Pass/Fail for this program was based on whether there was observed residual debris in the high speed video and appearance of the back of the target. No witness plate was utilized.

### Results

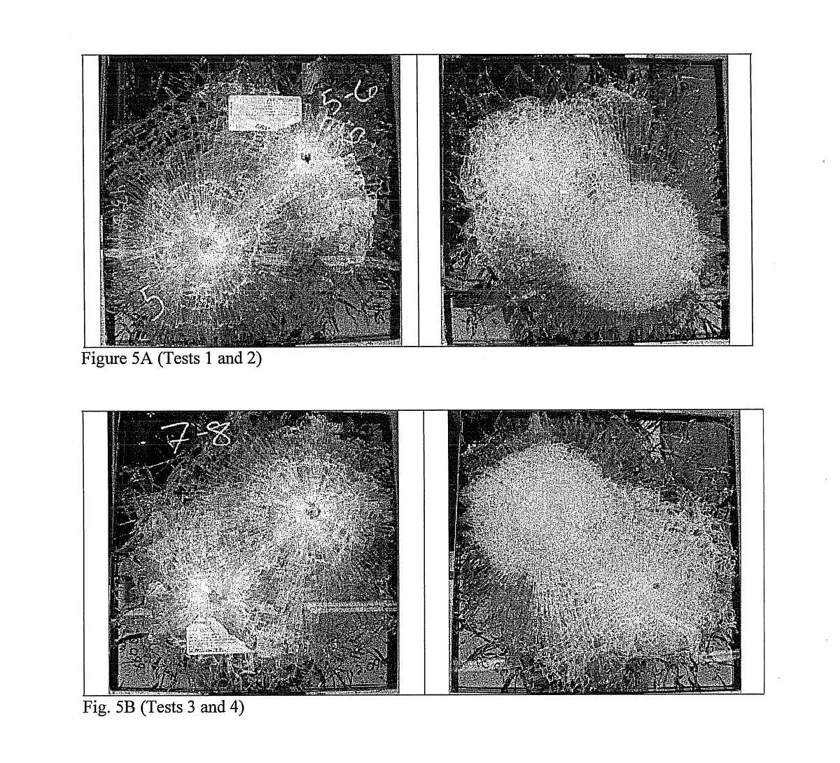

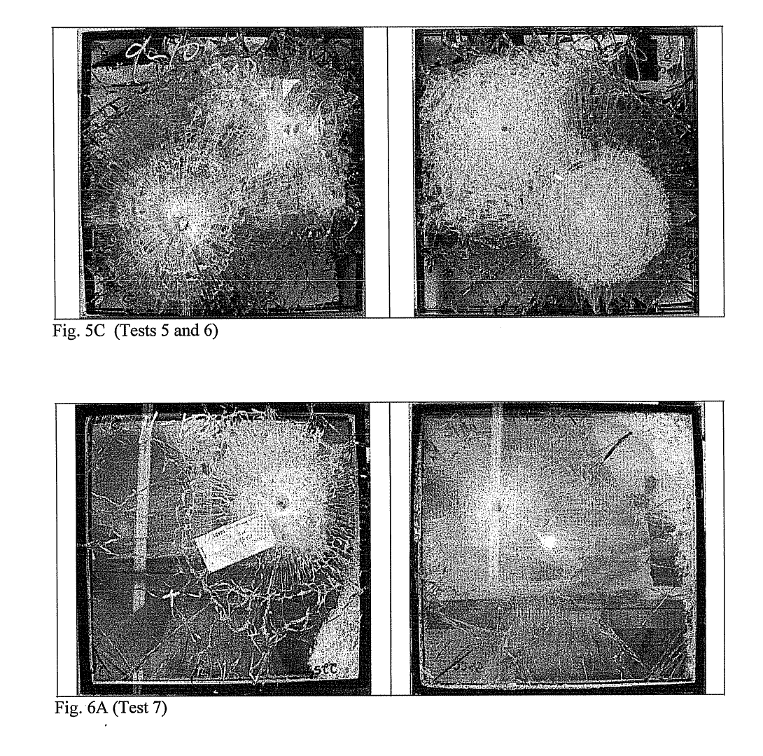

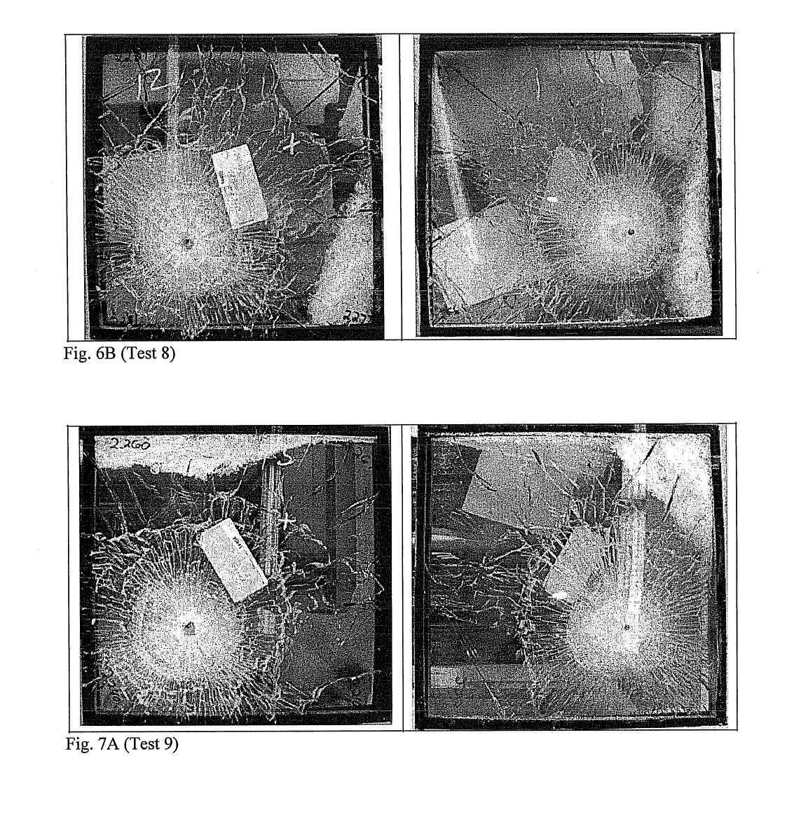

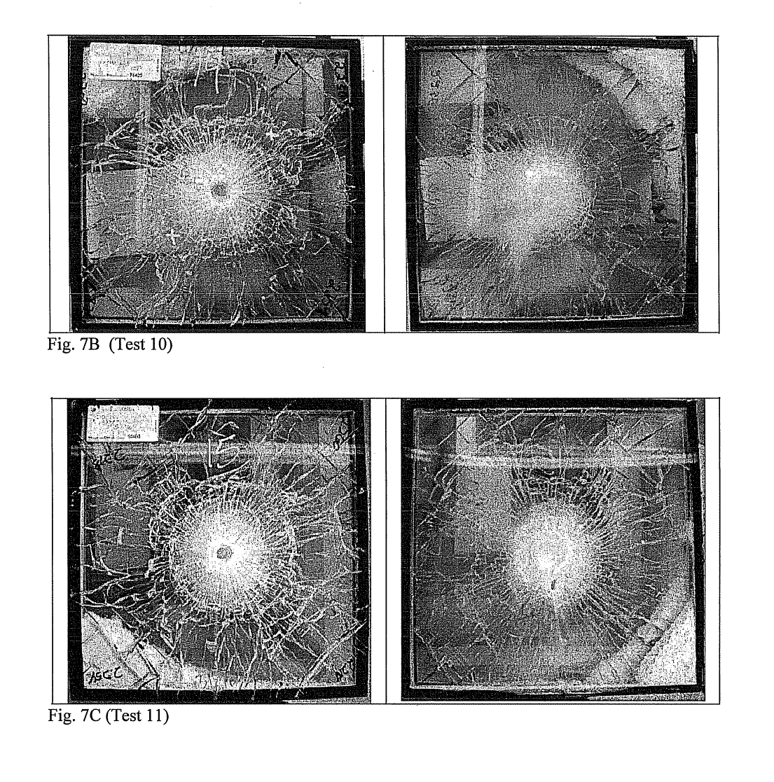

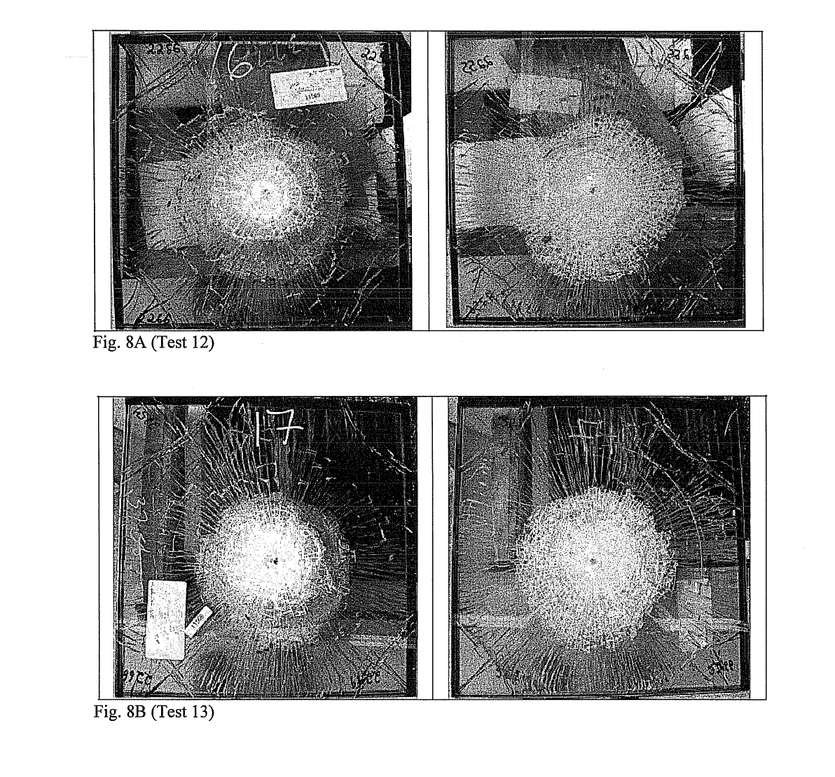

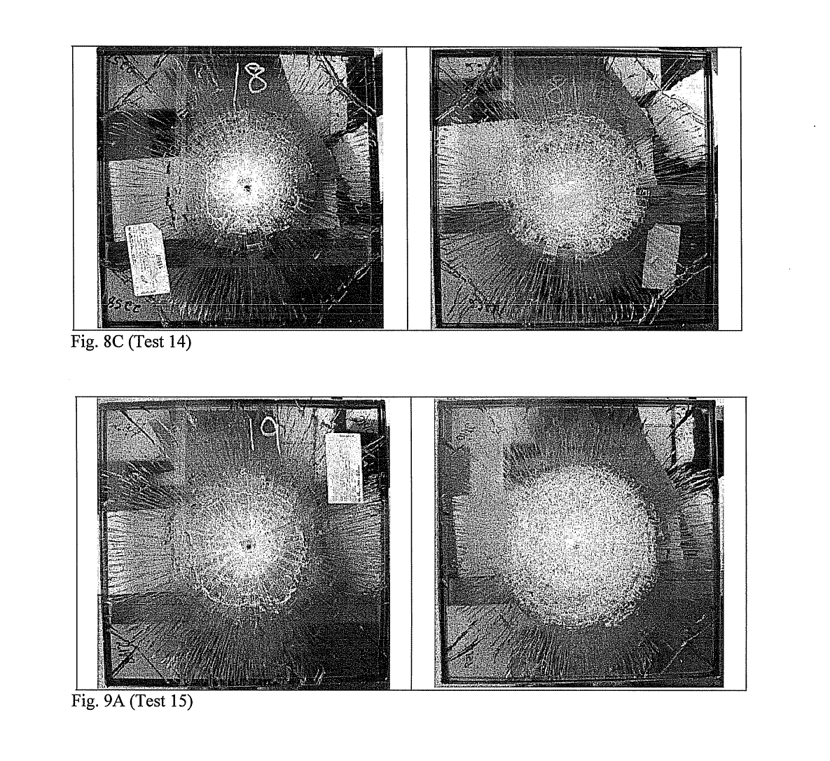

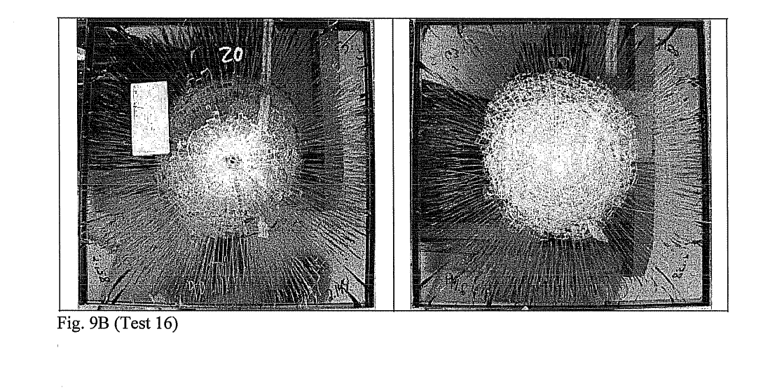

Table F shows the results of the ballistic testing with the corresponding strike velocities and residual velocities. Photos showing post-testing panels can be found in FIGS. 5-9. As indicated in Table F, the structure identified as W1 is approximately 30% lighter than the control (control 1). W2 and W3 are 14% and about 9% lighter that control 1, respectively. Each of W1, W2 and W3 are seen to alter the projectile trajectory and either retain the projectile or significantly reduce exit velocity. W1 (angled air-gap) is seen to significantly affect the outcome as compared to control 2 despite all three laminate layers being identical and essentially the only difference being the angle of the internal laminate, with results being comparable to the much heavier traditional laminate, control 1. Overall, in this study, an unexpectedly significant difference is seen between the “parallel” samples and those having non-parallel internal structures.

TABLE F
Cumulative Table of Results

| | | | | | | | Estimated | | | |
|---|---|---|---|---|---|---|---|---|---|---|
| | | | | | | Screen | Strike | Approximate | | |
| Test | | | Wt. | Thickness | Shot | Velocity | Velocity | Residual | | |
| No. | Threat | Target | (lb) | (in) | No. | (ft/s) | (fps) | Velocity (fps) | Pass/Fail | Comments |
| 1 | M61 | Control 1 | 43.89 | 2.1 | 1 of 2 | 2,787 | 2,787 | — | Pass | small bulge on back face |
| | | Sample 1 | | | | | | | | |
| 2 | M61 | Control 1 | 43.89 | 2.1 | 2 of 2 | 2,817 | 2,817 | 1,448 | Fail | core intact |
| | | Sample 1 | | | | | | | | |
| 3 | M61 | Control 1 | 43.97 | 2.1 | 1 of 2 | 2,823 | 2,823 | — | Pass | — |
| | | Sample 2 | | | | | | | | |
| 4 | M61 | Control 1 | 43.97 | 2.1 | 2 of 2 | 2,834 | 2,834 | 1,075 | Fail | core intact, yawed |
| | | Sample 2 | | | | | | | | |
| 5 | M61 | Control 1 | 43.1 | 2.1 | 1 of 2 | 2,849 | 2,849 | — | Pass | — |
| | | Sample 3 | | | | | | | | |
| 6 | M61 | Control 1 | 43.1 | 2.1 | 2 of 2 | 2,863 | 2,863 | 1,205 | Fail | core intact |
| | | Sample 3 | | | | | | | | |
| 7 | M61 | Control 2 | 31.5 | 2.26 | 1 of 1 | 2,859 | 2,859 | 1,941 | Fail | core intact |
| | | Sample 1 | | | | | | | | |
| 8 | M61 | Control 2 | 31.3 | 2.29 | 1 of 1 | 2,616 | 2,616 | 1,480 | Fail | core intact |
| | | Sample 2 | | | | | | | | |
| 9 | M61 | W1 | 31.24 | 2.24 | 1 of 1 | 2,587 | 2,587 | 1,121 | Fail | unable to see core-debris, |
| | | Sample 1 | | | | | | | | used mass residual |
| 10 | M61 | W1 | 31.37 | 2.24 | 1 of 1 | 2,348 | 2,348 | — | Pass | no back face cracks |
| | | Sample 2 | | | | | | | | |
| 11 | M61 | W1 | 31.14 | 2.28 | 1 of 1 | 2,533 | 2,533 | — | Pass | signs of backface stretch |
| | | Sample 3 | | | | | | | | |
| 12 | M61 | W2 | 37.72 | 2.25 | 1 of 1 | 2,818 | 2,818 | 1,396 | Fail | core intact |
| | | Sample 1 | | | | | | | | |
| 13 | M61 | W2 | 37.58 | 2.27 | 1 of 1 | 2,589 | 2,589 | 1,097 | Fail | core intact |
| | | Sample 2 | | | | | | | | |
| 14 | M61 | W2 | 37.69 | 2.26 | 1 of 1 | 2,268 | 2,268 | — | Pass | — |
| | | Sample 3 | | | | | | | | |
| 15 | M61 | W3 | 40.11 | 2.14 | 1 of 1 | 2,862 | 2,862 | 788 | Fail | — |
| | | Sample 1 | | | | | | | | |
| 16 | M61 | W3 | 40.1 | 2.14 | 1 of 1 | 2,599 | 2,599 | — | Pass | — |
| | | Sample 2 | | | | | | | | |

The present invention has been described with reference to specific details of particular embodiments thereof. It is not intended that such details be regarded as limitations upon the scope of the invention.

I claim:

1. Armor, comprising:
a first panel having a first surface and a second surface; and
a second panel having a first surface facing the second surface of the first panel and a second surface; and
wherein at least a portion of at least one of the first surface of the first panel and the second surface of the first panel is on a first plane that intersects a second plane defined by at least a portion of at least one of the first surface of the second panel and the second surface of the second panel.

2. The armor of claim 1, wherein the second surface of the first panel and the first surface of the second panel defines a first gap.

3. The armor of claim 1, further comprising a polymer between the second surface of the first panel and the first surface of the second panel.

4. The armor of claim 3, wherein the polymer is wedge shaped and has a first end that is wider than a second end.

5. The armor of claim 3, wherein the polymer comprises at least one of an acrylic polymer, a polycarbonate and a polyurethane.

6. The armor of claim 3, wherein the polymer comprises an aliphatic polyurethane.

7. The armor of claim 3, wherein the polymer comprises a cast transparent polyurethane.

8. The armor of claim 1, wherein the first panel and the second panel are of substantially uniform thickness, and wherein the second surface of the first panel and the first surface of the second panel are not parallel.

9. The armor of claim 1, wherein at least one of the first panel and the second panel is a laminate of a plurality of transparent, monolithic sheets.

10. The armor of claim 1, wherein at least one of the first panel and the second panel is a laminate of a plurality of transparent sheets.

11. The armor of claim 1, wherein at least one of the first panel and the second panel comprises float glass, tempered glass, annealed glass, low iron glass, borosilicate glass, silicic glass, highly silicic glass, tempered glass, fused silica, soda lime glass, a polyurethane (e.g., QUINTIUM), an polycarbonate, an acrylic, a glass ceramic, quartz crystal, crystal sapphire (crystal aluminum oxide, e.g., Al₂O₃), magnesium aluminate spinel (e.g., MgAl₂O₄), aluminum oxynitride spinel (AlON, e.g., Al₂₃O₂₇N₅), chemically strengthened glass, and super strength tempered glass.

12. The armor of claim 1, wherein at least one of the firs panel and the second panel is heat-resistant.

13. The armor of claim 1, wherein a thickness of at least one of the first panel and the second panel is variable.

14. The armor of claim 13, wherein at least one of the first panel and the second panel is wedge-shaped.

15. The armor of claim 1, wherein the second surface of the first panel and the first surface of the second panel are not parallel by at least 0.1 degrees, 0.5-2 degrees, 0.5-1 degrees, 0.8-0.9 degrees or about 0.85 degrees.

16. A window, comprising:
a frame; and
armor, the armor comprising:
a first panel having a first surface and a second surface; and
a second panel having a first surface facing the second surface of the first panel and a second surface; and
wherein at least a portion of at least one of the first surface of the first panel and the second surface of the first panel is on a first plane that intersects a second plane defined by at least a portion of at least one of the first surface of the second panel and the second surface of the second panel.

17. A method of making armor, the method comprising:
arranging a first panel having a first surface and a second surface with a second panel having a first surface facing the second surface of the first panel and a second surface; and
wherein at least a portion of at least one of the first surface of the first panel and the second surface of the first panel is arranged on a first plane that intersects a second plane defined by at least a portion of at least one of the first surface of the second panel and the second surface of the second panel.

18. The method of claim 17, wherein the first panel and the second panel are arranged such that the second surface of the first panel and the first surface of the second panel are not parallel.
